(19) United States
(12) Patent Application Publication
(10) Pub. No.: US 2026/0208594 A1
(43) Pub. Date: Jul. 23, 2026

(54) MODULAR BATTERY OF AN ELECTRIC VEHICLE

(71) Applicant: DRIVE ELECTRO SA, Lausanne (CH)

(72) Inventor: Sergey IVANOV, Kava Tivat (ME)

(21) Appl. No.: 19/140,639

(22) PCT Filed: Dec. 22, 2022
(86) PCT No.: PCT/IB2022/062670

§ 371 Date: Jun. 18, 2025

(51) Int. Cl. B60L 3/04; B60L 50/40; B60L 50/51; B60L 58/18; H01M 10/42; H01M 10/613; H01M 10/615; H01M 10/625; H01M 50/249; H01M 50/271

(52) U.S. Cl. CPC B60L 3/04; B60L 50/40; B60L 50/51; B60L 58/18; H01M 10/4264; H01M 10/613; H01M 10/615; H01M 10/625; H01M 50/249; H01M 50/271; B60L 2210/40; H01M 2220/20

(57) ABSTRACT

The invention relates to power sources for electric vehicles and may be used in the transport industry. The purpose of the present invention is to reduce the risk of damage to the electronic components of an electric vehicle during the operation of the modular battery (100,200,300,400). The purpose is achieved by the modular battery (100,200,300,400) of the electric vehicle due to the fact that the control unit (110,210,310,410) enables the execution of the traction motor inverter capacitor precharge logic.

### TECHNICAL DESCRIPTION

The invention relates to power sources for electric vehicles and may be used in the transport industry.

### PRIOR ART

The prior modular battery (MB) of an electric vehicle contains modules, each comprising battery packs connectable to a switching unit of the power supply circuit of a e-vehicle traction motor inverter [U.S. Pat. No. 7,960,943, publication date: Jun. 14, 2011. IPC: H02J 7/00].

The disadvantage of the known technical solution is a high risk of damage to electronic components of electric vehicle due to possible electrical malfunction of battery packs, resulting in reduced safety of modular battery operation.

The prototype is a modular battery of an electric vehicle containing modules, each comprising a control unit with battery packs connected, connectable to a switching unit of the power supply circuit of a e-vehicle traction motor inverter, wherein one of the control units ensures the receipt of data on the state of the battery packs, including data on the state of the battery packs from other control units, and data share with an electric vehicle control unit [CA3044173, publication date: Dec. 19, 2013. IPC: B60K 1/04; B60L 58/26; B60W 10/26].

The advantage of the prototype over the prior technical solution is a higher safety of modular battery due to the fact that each module contains a control unit with the battery packs connected, and the control unit of one of the modules collects data on the state of the battery packs from the control units of other modules, thereby monitoring electrical failures of the battery packs of each individual module, thus reducing the risk of damage to the electronic components of the electric vehicle during the modular battery operation.

The drawback of the prototype is still a high risk of damage to electronic components of an electric vehicle, in particular the switching unit of the power supply circuit of its traction motor inverter, due to the delay that inevitably occurs during the charging of the inverter capacitors when starting the traction motor and connecting the modular battery to the inverter power circuit, which may result in arcing between the contactor elements connecting the modular battery and the inverter, which leads to local temperature rise inevitably resulting in melting or welding of the contacts with each other and failure of the contactor or other electronic components of the electric vehicle.

### TECHNICAL PURPOSE

The purpose of the present invention is to reduce the risk of damage to the electronic components of an electric vehicle during the operation of the modular battery.

### SUMMARY OF THE INVENTION

One aspect of the present invention is a modular battery of an electric vehicle which contains modules, each comprising a control unit with battery packs connected, connectable to a switching unit of the power supply circuit of a e-vehicle traction motor inverter.

One of the control units ensures the receipt of data on the state of the battery packs connected and data on the state of the battery packs from the control units of other modules, and enables the execution of precharge logic of the traction motor inverter capacitors.

Another aspect of this invention is a method of reducing the risk of damage to electronic components of an electric vehicle during the modular battery operation, which consists in that one of the control units of one of the modules of the modular battery receives data on the state of the battery packs connected and data on the state of the battery packs from the control units of other modules and, taking into account these data, executes precharge logic of the traction motor inverter capacitors. In doing so, the control unit activates the capacitor precharge unit of the electric vehicle traction motor inverter, connected to the traction motor inverter power supply circuit.

### PURPOSE ACHIEVEMENT

The purpose of reducing the risk of damage to electronic components of electric vehicle in the operation of the modular battery is achieved by the fact that the modular battery additionally includes a capacitor precharge unit of the electric vehicle traction motor inverter, connected to the power circuit of the traction motor inverter, and the control unit enables the precharge logic being executed by the traction motor inverter capacitors.

### POSITIVE EFFECTS OF THE INVENTION

The modular battery may include a traction motor inverter capacitor precharge unit connected to the traction motor inverter power circuit, further reducing the risk of damage to the electronic components of the electric vehicle during the operation of the modular battery.

The modular battery may include additional traction motor inverter capacitor precharge units connected to the traction motor inverter power circuit, further reducing the risk of damage to the electronic components of the electric vehicle during the operation of the modular battery.

Each module may include a motherboard or other integrated board which may have a capacitor precharge unit, a contactor connecting each battery module and inverter, and a control unit for each module, further reducing the risk of damage to the electronic components of the electric vehicle during the operation of the modular battery.

Each module may include a circuit breaker that provides a positive opening of the electrical circuit between the battery packs, further reducing the risk of damage to the electronic components of the electric vehicle during repair or maintenance of the modular battery.

Each module or modular battery may contain a lid enclosure with a limit switch ensuring the interruption of the traction motor inverter power circuit when the lid is opened, further reducing the risk of damage to electronic components of the electric vehicle during repair or maintenance of the modular battery.

The traction motor inverter capacitor precharge unit may be designed as a series-connected high voltage relay and current-limiting resistor, further reducing the risk of damage to the electronic components of the electric vehicle during operation of the modular battery.

When executing the traction motor inverter capacitor precharge logic, the control unit may poll control units of other modules for feedback, and if there is no feedback, and, if no feedback is available, it may send a signal of modular battery failure to the control unit of the electric vehicle and disable one of the modules or the entire modular battery, further reducing the risk of damage to electronic components of the electric vehicle during operation of the modular battery.

When executing the traction motor inverter capacitor precharge logic, the control unit may receive data (from the control units of other modules) on the status of battery packs, including control units of other modules, and in case of deviation of these parameters from the allowable values, it may send a signal of the modular battery failure to the control unit of the electric vehicle and/or disable one of the modules or the entire modular battery, further reducing the risk of damage to electronic components of the electric vehicle during operation of the modular battery.

When executing the traction motor inverter capacitor precharge logic, the control unit may send a control signal 0.3-0.8 s in length, to the capacitor precharge unit, further reducing the risk of damage to the electronic components of the electric vehicle during the operation of the modular battery. In this case, the length of the control signal sent by the control unit to the precharge capacitor unit may be at least 0.5 s, which also further reduces the risk of damage to the electronic components of the electric vehicle during the operation of the modular battery.

When executing the traction motor inverter capacitor precharge logic, the control unit may send a control signal prior to the reduction of the value of the current coming from the battery packs, which further reduces the risk of damage to the electronic components of the electric vehicle during the operation of the modular battery. At the same time the control signal may be applied until the current value is 1 to 2 A, which further reduces the risk of damage to the electronic components of the electric vehicle during the operation of the modular battery.

The control unit may enable the logic being executed for detection of unbalanced electrical performance of modules by comparing the values of voltage or current parameters of different modules with each other, which, if the module with the largest deviations is turned off, further reduces the risk of damage to electronic components of the electric vehicle during the operation of the modular battery.

If more than one capacitor and/or inverter and/or traction motor is available in the electric vehicle design, the control unit may execute a selection logic for one or all of the capacitors, inverters or traction motors. Such a logic may be executed if there is a need to shift the drive axles of the vehicle, if one of the above-mentioned components of the electric vehicle fails, if there is a need to activate all the above-mentioned components to provide maximum power, etc. It may also be executed if there is a need to operate auxiliary capacitors, inverters or traction motors (if any) of special equipment which uses the consumers connected separately from the main traction motor for operational reasons.

The control unit or optional controller may accumulate data on the state of the battery packs and store this data in the internal memory, which provides the possibility of keeping statistics and also further reduces the risk of damage to the electronic components of the electric vehicle during the operation of the modular battery.

Modules may contain heaters and/or coolers for battery packs, which also further reduces the risk of damage to the electronic components of the electric vehicle during operation of the modular battery.

Modules may contain communication tools using any known communications protocol (optical or laser line, telephone or coaxial wire, CAN bus, Ethernet, GSM, wireless WiFi, Bluetooth or other wired and wireless standards, including those commonly used in Web 3.0, Web 4.0, IoT) which transmit battery pack status and battery pack operation statistics to other switching or control units in the vehicle or to external devices (such as a server, communication hub, dispatch center, other vehicle, charging station control unit, traffic control unit, sensors and other receiving devices) or provide two-way exchange of meaningful information, including commands and instructions, and updated software.

### BRIEF DESCRIPTION OF THE DRAWINGS

FIG. 1 shows a functional diagram of a modular battery connected to the electric motor power circuit of an electric vehicle, wherein the capacitor precharge unit and the power circuit switching unit, designed as a contactor, are made as separate elements.

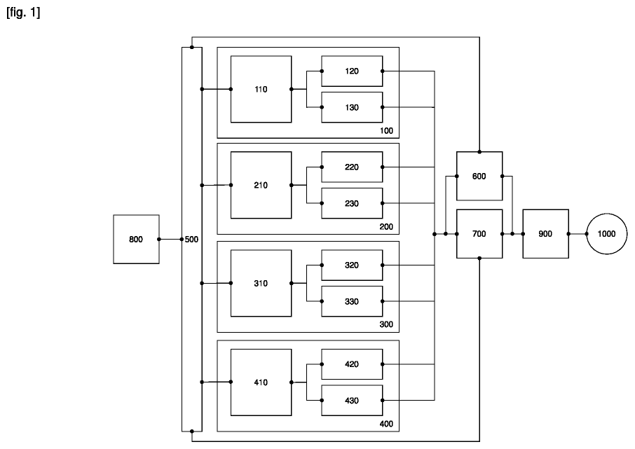

FIG. 2 shows the functional diagram of a modular battery connected to the electric motor power circuit of an electric vehicle, with the capacitor precharge unit and the power circuit switching unit, designed as a contactor, being integrated into each battery module.

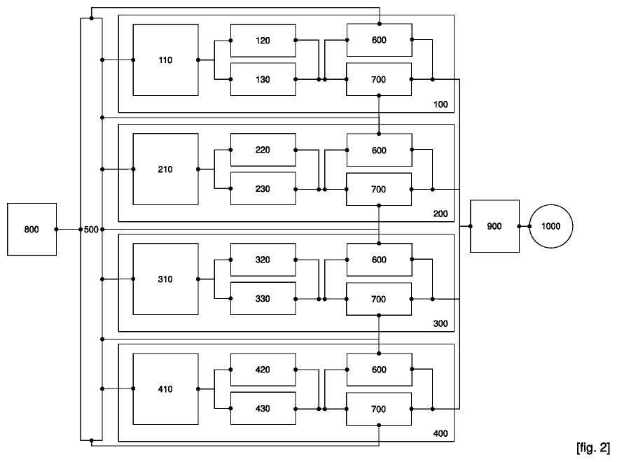

FIG. 3 shows the precharge logic of the traction motor inverter capacitors, executed by the master control unit of the modular battery of an electric vehicle.

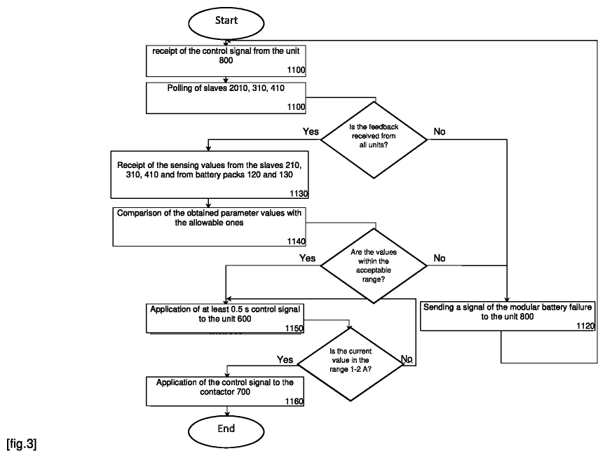

### DESCRIPTION OF EMBODIMENT

An embodiment, which may be amended or supplemented in any way, is given below to demonstrate the feasibility and better understanding of the essence of the invention, whereby the present invention is by no means limited by the embodiment presented.

### Parameters

The modular battery of an electric vehicle, which may include a bus, truck or passenger car, aircraft, including space machinery, tunnel vehicle, floating vehicle, including underwater vehicles, utility and service vehicles, including their robotic and unmanned versions, contains modules 100, 200, 300 and 400, each of which may be located in its own or shared sealed enclosure, includes modules 100, 200, 300, and 400, each of which may be arranged in its own or a common sealed enclosure, includes a control unit 110, 210, 310, 410 which may be designed as a chip, controller, or processor, and battery packs 120, 130, 220, 230, 320, 330, 420, 430, which may be designed as individual elements or cells with heaters and coolers in the form of electrical elements connected to the control units 110, 210, 310, 410 or heat exchangers with heatsink units. In addition, the modules 100, 200, 300 and 400 also contain battery pack status sensors, such as voltage, current, temperature sensors, etc.

In addition, the modular battery contains a CAN bus 500, or other means for sharing data between electronic components, such as a cable or optical fiber, and a precharge unit 600 for traction motor inverter capacitors of an electric vehicle, containing a series-connected high voltage relay or other electrical circuit switcher, and a limiting resistor, mounted in one of the modules, or presented as separate elements.

The control units 110, 210, 310 and 410 are interconnected, and connected (via CAN bus 500) to the capacitor precharge unit 600, the contactor 700, the electric vehicle control unit 800 and the inverter 900; the inverter 900 is connected to the electric vehicle traction motor 1000.

When the electric vehicle is put into operation, the control unit 110 is set by the operator as the Master, the other units are designated as Slaves. The units 110, 210, 310 and 410 may also be set remotely by the control center generating the appropriate commands, including in automated mode, without operator involvement. Master/Slave switching may be performed mechanically or electronically by setting the appropriate role in the unit software. To increase reliability, it is also possible to change Master/Slave using an electronically controlled robotic mechanical relay. However, to prevent two or more Master units from being applied simultaneously, the device may contain a mechanical or electronic safety interlock that limits the simultaneous application of several Master units and limits the application of another Master unit in case the one is already applied.

When starting or other activation by the user of an electric vehicle, and if the vehicle is connected to the charger in step 1100, a control signal is sent from the control unit 800 to the control unit 110 to enable the execution of the traction motor inverter capacitor precharge logic. The logic may also be activated when the device “wakes up”, for example, when waiting for a long time in a traffic jam or an intermediate stop, or when consumers otherwise need to be in power-saving mode. The logic may also be activated if several traction motors 1000 are installed on one vehicle, each of which may be operated independently.

When executing this algorithm, unit 110 first performs step 1110 to poll the slaves 210, 310, 410 for feedback and, if no feedback is available, at step 1120 unit 110 signals to unit 800 that the modular battery has failed, and it is disabled.

If the slaves 210, 310, 410 are successfully polled by the unit 110, step 1130 is performed to receive the sensing parameters, such as temperature, voltage, current, etc., from them and from the battery packs 120 and 130.

Then, step 1140 compares the resulting parameter values with the allowable values that are stored in its internal memory. If the parameter values are outside of the parameter value ranges, then unit 110 initiates step 1120 and signals to unit 800 about the failure of the modular battery, and it is disabled.

If the parameter values are within the tolerance ranges, then unit 110 initiates step 1150 and sends at least 0.5 s signal to the capacitor precharge unit 600, enabling the closure of the high voltage relay and thereby the charging of the capacitors of the inverter 900 of the electric vehicle traction motor from via the battery packs 120, 130, 220, 230, 320, 330, 420, 430.

The control signal is applied by the control unit 110 before the battery packs 120, 130, 220, 230, 320, 330, 420, 430 decrease current rate to a value of 1-2 A. Then, in step 1160, the control unit 110 applies a control signal to the contactors 700, ensuring that the circuit is closed without the risk of melting the contact elements and causing it to fail. The logic-driven data on the state of the battery packs 120, 130, 220, 230, 320, 330, 420, 430 are stored by the unit 110 in the internal memory and may be further used to collect statistics regarding the state of the modular battery

### INDUSTRIAL FEASIBILITY

The invention may be made from known materials using known tools, which evidences its compliance with the patentability criterion of “industrial feasibility”.

### PATENT LITERATURE

Patent literature 1: Patent EP3723157

Patent literature 2: Patent CA3044173

1. A modular battery (MB) of an electric or hybrid vehicle containing:
modules, each of which includes a control unit with at least one battery pack connectable to the power supply circuit switcher of a e-vehicle traction motor inverter, wherein:
one of the control units enables:
the receipt of data on the status of one or more battery packs connected, and data on the status of battery packs from other control units, the data sharing with the control unit of the electric vehicle;
the execution of the traction motor inverter capacitor precharge logic. The control unit, when executing the traction motor inverter capacitor precharge logic, sends at least 0.3-0.8 s. control signal to the capacitor precharge unit.

2. The modular battery of claim 1, which additionally includes the capacitor precharge unit of a e-vehicle traction motor inverter, connected to the traction motor inverter power circuit.

3. The modular battery of claim 2, each module of which includes a motherboard or other integration board with a mounted-in capacitor precharge unit, a contactor connecting each battery module and inverter, and a control unit for each module.

4. The modular battery of claim 2, with the capacitor precharge unit of the traction motor inverter being designed as a series-connected high-voltage relay and a current-limiting resistor.

5. The modular battery of claim 1, which control unit enables the execution of logic to select one or all of the e-vehicle capacitors, and/or inverters, and/or traction motors.

6. The modular battery of claim 1, which control unit, when executing the traction motor inverter capacitor precharge logic, polls the control units of other modules for feedback, and in the absence of feedback, sends a signal of the modular battery failure to the control unit of the electric vehicle and/or disables one of the modules or the entire modular battery.

7. The modular battery of claim 1, which control unit, when executing the traction motor inverter capacitor precharge logic, provides data on the state of the battery packs, including from the control units of other modules, and in case of deviation of these parameters from the allowable values, sends a signal of the modular battery failure to the control unit of the electric vehicle and/or disables one of the modules or the entire modular battery.

8. (canceled)

9. The modular battery of claim 1, with at least 0.5 s. signal being sent by the control unit to the precharge capacitor unit.

10. The modular battery of claim 1, which control unit, when executing the traction motor inverter capacitor precharge logic, sends the control signal until the value of the current coming from the battery packs decreases.

11. The modular battery of claim 10, which control unit sends the control signal until the current value decreases to a value between 1 and 2 A.

12. The modular battery of claim 1, which control unit enables the execution of logic for detecting the unbalanced electrical performance of modules.

13. The modular battery of claim 1, which modules contain heaters and/or coolers for the battery packs.

14. The modular battery of claim 1, each module of which includes a power switch that provides a positive opening of the electrical circuit between the battery packs.

15. The modular battery of claim 1, each module of which (or the entire modular battery) contain a lid enclosure with a limit switch to ensure that the traction motor inverter supply circuit opens when the lid is opened.

16. A method of reducing the risk of damage to electronic components of an electric vehicle during the operation of a modular battery, which is that:
one of the control units of one of the modular battery modules receives data on the status of the battery packs connected, and data on the status of the battery packs from the control units of other modules
precharge logic of the electric vehicle traction motor inverter capacitors is executed, by involving the capacitor precharge unit of the electric vehicle traction motor inverter connected to the power supply circuit of the traction motor inverter. The control unit, when executing the traction motor inverter capacitor precharge logic, sends at least 0.3 to 0.8 s control signal to the capacitor precharge unit.

17. Method of claim 16, whereby the control unit, when executing the traction motor inverter capacitor precharge logic, polls the control units of the other modules for feedback, and if no feedback is available, sends a signal of the modular battery failure to the control unit of the electric vehicle and/or disables one of the modules or the entire modular battery.

18. Method of claim 16, whereby the control unit, when executing the traction motor inverter capacitor precharge logic, receives data on the state of the battery packs, including from the control units of other modules and, in case of deviation of these parameters from allowable values, sends a signal about the modular battery failure to the control unit of the electric vehicle and/or disables one of the modules or the entire modular battery.

19. (canceled)

20. Method of claim 16, whereby the length of the signal sent by the control unit to the capacitor precharge unit is at least 0.5 s.

21. The method of claim 16, whereby the control unit, when executing the traction motor inverter capacitor precharge logic, applies the control signal until the value of the current coming from the battery packs decreases.

22. The method of claim 21, whereby the control unit applies the control signal until the current value is reduced to a value between 1 and 2 A.

23. The method of claim 16, whereby the control unit executes logic for detecting unbalanced electrical performance of modules.

24. The method of claim 16, whereby if electric vehicle has more than one capacitor and/or inverter and/or traction motor, the control unit executes logic to select one or all of the capacitors, inverters or traction motors.

25. Method of claim 16, whereby the control unit executes the traction motor inverter capacitor precharge logic when the modular battery “wakes up”.

26. Method of claim 16, whereby the control unit executes the traction motor inverter capacitor precharge logic in the case where several traction motors are installed on the same vehicle, which each being operated independently.
